(19) United States
(12) Patent Application Publication
(10) Pub. No.: US 2026/0073460 A1
(43) Pub. Date: Mar. 12, 2026

(54) RESTAURANT MANAGEMENT SYSTEM

(71) Applicant: MicroLogX, Inc., Fuquay Varina, NC (US)

(72) Inventors: Arken Elhicheri, Fuquay Varina, NC (US); Stephen Overton, Holly Springs, NC (US)

(21) Appl. No.: 18/882,953

(22) Filed: Sep. 12, 2024

(51) Int. Cl. G06Q 50/12; G06Q 30/0283

(52) U.S. Cl. CPC G06Q 50/12; G06Q 30/0283

(57) ABSTRACT

Restaurant management system including restaurant management database programmed for storage and retrieval of restaurant management data including restaurant supply pricing data correlated with restaurant menu pricing data. System includes electronic restaurant menu display for displaying restaurant menu pricing data. System includes restaurant management system processor programmed for control of electronic restaurant menu display and for analysis of restaurant management data. System processor is programmed for receiving, analyzing and correlating together updated restaurant supply pricing data and updated restaurant menu pricing data forming updated restaurant management data. System processor is programmed for communicating updated restaurant management data to restaurant management database. System processor is programmed for retrieving updated restaurant menu pricing data from the restaurant management database and communicating updated restaurant menu pricing data to electronic restaurant menu display.

### BACKGROUND OF THE INVENTION

### 1. Field of the Invention.

The present invention relates to the field of restaurant management systems.

### 2. Background of the Invention.

Systems and processes have been developed for managing restaurants. Despite the existence of these systems and processes, further improvements are still needed in restaurant management systems.

### SUMMARY

In an example of an implementation, a restaurant management system is provided, including a restaurant management database, an electronic restaurant menu display, and a restaurant management system processor. In the example of the restaurant management system, the restaurant management database is programmed for storage and retrieval of restaurant management data including restaurant supply pricing data being correlated with restaurant menu pricing data. Further in the example of the restaurant management system, the electronic restaurant menu display is for displaying the restaurant menu pricing data. Additionally in the example of the restaurant management system, the restaurant management system processor is programmed for control of the electronic restaurant menu display and for analysis of the restaurant management data, the restaurant management system processor being programmed for receiving, analyzing and correlating together updated restaurant supply pricing data and updated restaurant menu pricing data forming updated restaurant management data, the restaurant management system processor being programmed for communicating the updated restaurant management data to the restaurant management database, the restaurant management system processor being programmed for retrieving the updated restaurant menu pricing data from the restaurant management database and communicating the updated restaurant menu pricing data to the electronic restaurant menu display.

In some examples of the implementation of the restaurant management system, the restaurant management system processor may be programmed for generating some of the restaurant menu pricing data by analyzing the restaurant management data.

In further examples of the implementation of the restaurant management system, the restaurant management system processor may be programmed for receiving restaurant supply pricing data from crowd sourcing across a plurality of restaurants.

In additional examples of the implementation of the restaurant management system, the restaurant management system processor may be programmed for receiving restaurant menu pricing data from crowd sourcing across a plurality of restaurants.

In other examples of the implementation of the restaurant management system, the restaurant management system processor may be programmed for receiving restaurant supply pricing data and restaurant menu pricing data from internet crowd sourcing across a plurality of restaurants.

In some examples of the implementation of the restaurant management system, the restaurant management system processor may be programmed for real-time updating of the restaurant menu pricing data.

In further examples of the implementation of the restaurant management system, the restaurant management system processor may be programmed for real-time updating of the electronic restaurant menu display.

In additional examples of the implementation of the restaurant management system, the restaurant management system processor may be programmed for real-time monitoring of the restaurant supply pricing data.

In other examples of the implementation of the restaurant management system, the restaurant management system processor may be programmed for real-time updating of the restaurant menu pricing data in accordance with the updated restaurant supply pricing data.

In some examples of the implementation of the restaurant management system, the restaurant management system processor may be programmed for receiving a set of rules for analysis of the restaurant supply pricing data in correlating the restaurant supply pricing data together with the restaurant menu pricing data.

In further examples of the implementation of the restaurant management system, the restaurant management system processor may be programmed for receiving the set of rules for analysis of the restaurant supply pricing data as including a menu pricing scheme tailored to a selected restaurant type in correlating the restaurant supply pricing data with the restaurant menu pricing data in the restaurant management data.

In additional examples of the implementation of the restaurant management system, the set of rules for analysis of the restaurant supply pricing data may include set points for executing placement of an order for a restaurant supply when the restaurant supply pricing data reach a specified amount.

In other examples of the implementation of the restaurant management system, the restaurant management system processor may be programmed for placing a limit order for a restaurant supply in response to the updated restaurant supply pricing data.

In some examples of the implementation of the restaurant management system, the restaurant management system processor may be programmed for generating artificial intelligence training data for storage in and retrieval from the restaurant management database and for utilizing the artificial intelligence training data for analysis of potential outcomes in the restaurant menu pricing data.

In further examples of the implementation of the restaurant management system, the restaurant management system processor may be programmed for correlating the artificial intelligence training data with the restaurant management data.

In additional examples of the implementation of the restaurant management system, the restaurant management system processor may be programmed for generating optimal outcome data from the analysis of potential outcomes in the restaurant menu pricing data.

In other examples of the implementation of the restaurant management system, the restaurant management system processor may be programmed for receiving the updated restaurant supply pricing data from the Internet and for causing the restaurant supply pricing data stored in the restaurant management database to be updated in accordance with the updated restaurant supply pricing data.

In some examples of the implementation of the restaurant management system, the restaurant management database may be programmed for storage and retrieval of restaurant supply availability data.

In further examples of the implementation of the restaurant management system, the restaurant management system processor may be programmed for correlating the restaurant supply availability data with the restaurant management data.

In additional examples of the implementation of the restaurant management system, the restaurant management system processor may be programmed for receiving updated restaurant supply availability data and for causing the restaurant supply availability data stored in the restaurant management database to be updated in accordance with the updated restaurant supply availability data.

In other examples of the implementation of the restaurant management system, the restaurant management system processor may be programmed for real-time updating of the restaurant menu pricing data in accordance with the updated restaurant supply availability data.

In some examples of the implementation of the restaurant management system, the restaurant management system processor may be programmed for receiving a set of rules for analysis of the restaurant supply availability data in correlating the restaurant supply availability data together with the restaurant menu pricing data.

In further examples of the implementation of the restaurant management system, the restaurant management system processor may be programmed for real-time monitoring of the restaurant supply availability data.

In additional examples of the implementation of the restaurant management system, the restaurant management system processor may be programmed for placing an order for a restaurant supply in response to the updated restaurant supply availability data.

In other examples of the implementation of the restaurant management system, the restaurant management system processor may be programmed for placing a limit order for a restaurant supply in response to the updated restaurant supply availability data.

In some examples of the implementation of the restaurant management system, the restaurant management system processor may be programmed for generating artificial intelligence training data for storage in and retrieval from the restaurant management database and for utilizing the artificial intelligence training data for analysis of potential outcomes in the restaurant menu pricing data.

In further examples of the implementation of the restaurant management system, the restaurant management system processor may be programmed for correlating the artificial intelligence training data with the restaurant management data.

In additional examples of the implementation of the restaurant management system, the restaurant management system processor may be programmed for generating optimal outcome data from the analysis of potential outcomes in the restaurant supply availability data.

In other examples of the implementation of the restaurant management system, the restaurant management system processor may be in communication with an electronic menu updating facility.

In some examples of the implementation of the restaurant management system, the restaurant management system processor may be programmed for utilizing the electronic menu updating facility for real-time updating of the electronic restaurant menu display.

In further examples of the implementation of the restaurant management system, the restaurant management database may be programmed for storage and retrieval of restaurant supplier data.

In additional examples of the implementation of the restaurant management system, the restaurant management system processor may be programmed for correlating the restaurant supplier data with the restaurant management data.

In other examples of the implementation of the restaurant management system, the restaurant management system processor may be programmed for receiving updated restaurant supplier data and for causing the restaurant supplier data stored in the restaurant management database to be updated in accordance with the updated restaurant supplier data.

In some examples of the implementation of the restaurant management system, the restaurant management system processor may be programmed for real-time updating of the restaurant menu pricing data in accordance with the updated restaurant supplier data.

In further examples of the implementation of the restaurant management system, the restaurant management system processor may be programmed for receiving a set of rules for analysis of the restaurant supplier data in correlating the restaurant supplier data together with the restaurant menu pricing data.

In additional examples of the implementation of the restaurant management system, the restaurant management system processor may be programmed for real-time monitoring of the restaurant supplier data.

In other examples of the implementation of the restaurant management system, the restaurant management system processor may be programmed for placing an order for a restaurant supply in response to the updated restaurant supplier data.

In some examples of the implementation of the restaurant management system, the restaurant management system processor may be programmed for generating artificial intelligence training data for storage in and retrieval from the restaurant management database for analysis of potential outcomes in the restaurant supplier data.

In further examples of the implementation of the restaurant management system, the restaurant management system processor may be programmed for correlating the artificial intelligence training data with the restaurant management data.

In additional examples of the implementation of the restaurant management system, the restaurant management system processor may be programmed for generating optimal outcome data from analysis of potential outcomes in the restaurant supplier data.

In other examples of the implementation of the restaurant management system, the restaurant management database may be programmed for storage and retrieval of the restaurant supplier data as including contact information and physical locations of restaurant suppliers.

In some examples of the implementation of the restaurant management system, the restaurant management database may be programmed for storage and retrieval of historical restaurant supply product quality data correlated with the contact information and physical locations of restaurant suppliers.

In further examples of the implementation of the restaurant management system, the restaurant management system processor may be programmed for correlating the historical restaurant supply product quality data with the restaurant management data.

In additional examples of the implementation of the restaurant management system, the restaurant management system processor may be programmed for receiving a set of rules for analysis of the historical restaurant supply product quality data in carrying out the correlating of the historical restaurant supply product quality data with the restaurant management data.

In other examples of the implementation of the restaurant management system, the restaurant management database may be programmed for storage and retrieval of historical restaurant supply product quality data correlated with updated restaurant supply availability data.

In some examples of the implementation of the restaurant management system, the restaurant management database may be programmed for storage and retrieval of supplier historical product volume order pricing data correlated with the contact information and physical locations of restaurant suppliers.

In further examples of the implementation of the restaurant management system, the restaurant management database may be programmed for storage and retrieval of updated restaurant supply availability data correlated with the contact information and physical locations of restaurant suppliers.

In additional examples of the implementation of the restaurant management system, the restaurant management database may be programmed for storage and retrieval of restaurant supply inventory data.

In other examples of the implementation of the restaurant management system, the restaurant management system processor may be programmed for correlating the restaurant supply inventory data with the restaurant management data.

In some examples of the implementation of the restaurant management system, the restaurant management system processor may be programmed for receiving updated restaurant supply inventory data and for causing the restaurant supply inventory data stored in the restaurant management database to be updated in accordance with the updated restaurant supply inventory data.

In further examples of the implementation of the restaurant management system, the restaurant management system processor may be programmed for real-time updating of the restaurant menu pricing data in accordance with the updated restaurant supply inventory data.

In additional examples of the implementation of the restaurant management system, the restaurant management system processor may be programmed for updating the electronic restaurant menu display in accordance with the updated restaurant supply inventory data.

In other examples of the implementation of the restaurant management system, the restaurant management system processor may be programmed for deleting a menu item from the electronic restaurant menu display in response to the updated restaurant supply inventory data or the updated restaurant supply pricing data.

In some examples of the implementation of the restaurant management system, the restaurant management database may be programmed for storage and retrieval of the restaurant supply inventory data as including restaurant supply inventory expiration data, and wherein the restaurant management system processor may be programmed for utilizing the restaurant supply inventory expiration data in updating the restaurant supply inventory data.

In further examples of the implementation of the restaurant management system, the restaurant management system processor may be programmed for receiving a set of rules for analysis of the restaurant supply inventory data in correlating the restaurant supply inventory data together with the restaurant management data.

In additional examples of the implementation of the restaurant management system, the restaurant management system processor may be programmed for real-time monitoring of the restaurant supply inventory data.

In other examples of the implementation of the restaurant management system, the restaurant management system processor may be programmed for placing an order for a restaurant supply in response to the updated restaurant supply inventory data.

In some examples of the implementation of the restaurant management system, the restaurant management system processor may be programmed for placing an order for a restaurant supply in response to the updated restaurant supply inventory data.

In further examples of the implementation of the restaurant management system, the restaurant management system processor may be programmed for placing a limit order for a restaurant supply in response to the updated restaurant supply inventory data.

In additional examples of the implementation of the restaurant management system, the restaurant management system processor may be programmed for generating artificial intelligence training data relating to the restaurant supply inventory data for storage in and retrieval from the restaurant management database for analysis of potential outcomes in the restaurant supply inventory data.

In other examples of the implementation of the restaurant management system, the restaurant management system processor may be programmed for correlating the artificial intelligence training data relating to the restaurant supply inventory data together with the restaurant management data.

In some examples of the implementation of the restaurant management system, the restaurant management system processor may be programmed for generating optimal outcome data from the analysis of potential outcomes in the restaurant supply inventory data.

In further examples of the implementation of the restaurant management system, the restaurant management system processor may be in communication with an electronic menu updating facility.

In additional examples of the implementation of the restaurant management system, the restaurant management system processor may be programmed for utilizing the electronic menu updating facility for real-time updating of the electronic restaurant menu display.

In other examples of the implementation of the restaurant management system, the restaurant management database may be programmed for storage and retrieval of customer personal history and feedback data.

In some examples of the implementation of the restaurant management system, the restaurant management database may be programmed for storage and retrieval of restaurant menu item ingredient specifications.

In further examples of the implementation of the restaurant management system, the restaurant management database may be programmed for storage and retrieval of ingredient specifications for a restaurant menu item, and wherein the restaurant management system processor may be programmed for determining a preparation cost for the restaurant menu item by applying a set of rules for analysis of the restaurant supply pricing data.

In additional examples of the implementation of the restaurant management system, the restaurant management system processor may be programmed for receiving restaurant menu pricing data from crowd sourcing across a plurality of restaurants.

In other examples of the implementation of the restaurant management system, the restaurant management system processor may be programmed for receiving restaurant supply pricing data and restaurant menu pricing data from internet crowd sourcing across a plurality of restaurants.

In some examples of the implementation of the restaurant management system, the restaurant management system processor may be programmed for real-time updating of the restaurant menu pricing data.

In further examples of the implementation of the restaurant management system, the restaurant management system processor may be programmed for real-time updating of the electronic restaurant menu display.

In additional examples of the implementation of the restaurant management system, the restaurant management system processor may be programmed for real-time monitoring of the restaurant supply pricing data.

In other examples of the implementation of the restaurant management system, the restaurant management system processor may be programmed for real-time updating of the restaurant menu pricing data in accordance with the updated restaurant supply pricing data.

In some examples of the implementation of the restaurant management system, the restaurant management system processor may be programmed for receiving the set of rules for analysis of the restaurant supply pricing data as including a menu pricing scheme tailored to a selected restaurant type in correlating the restaurant supply pricing data with the restaurant menu pricing data in the restaurant management data.

In further examples of the implementation of the restaurant management system, the set of rules for analysis of the restaurant supply pricing data may include set points for executing placement of an order for a restaurant menu item ingredient when the restaurant supply pricing data reach a specified amount.

In additional examples of the implementation of the restaurant management system, the restaurant management system processor may be programmed for generating artificial intelligence training data for storage in and retrieval from the restaurant management database and for utilizing the artificial intelligence training data for analysis of potential outcomes in the customer personal history and feedback data.

In other examples of the implementation of the restaurant management system, the restaurant management system processor may be programmed for correlating the artificial intelligence training data with the restaurant management data.

In some examples of the implementation of the restaurant management system, the restaurant management system processor may be programmed for generating optimal outcome data from the analysis of potential outcomes in the customer personal history and feedback data.

In further examples of the implementation of the restaurant management system, the restaurant management system processor may be programmed for generating artificial intelligence training data for storage in and retrieval from the restaurant management database and for utilizing the artificial intelligence training data for analysis of potential outcomes in the ingredient specifications.

In additional examples of the implementation of the restaurant management system, the restaurant management system processor may be programmed for correlating the artificial intelligence training data with the restaurant management data.

In other examples of the implementation of the restaurant management system, the restaurant management system processor may be programmed for generating optimal outcome data from the analysis of potential outcomes in the ingredient specifications.

In some examples of the implementation of the restaurant management system, the restaurant management system processor may be programmed for receiving the updated restaurant supply pricing data from the Internet and for causing the restaurant supply pricing data stored in the restaurant management database to be updated in accordance with the updated restaurant supply pricing data

In further examples of the implementation of the restaurant management system, the restaurant management system processor may be programmed for determining a profit margin for the restaurant menu item based on a determined preparation cost.

In additional examples of the implementation of the restaurant management system, the restaurant management system processor may be programmed for ranking determined profit margins for a plurality of potential restaurant menu items based on their respective determined preparation costs.

In other examples of the implementation of the restaurant management system, the restaurant management system processor may be programmed for correlating the profit margins with the customer personal history or feedback data or ingredient specification data in the restaurant management data.

In some examples of the implementation of the restaurant management system, the restaurant management database may be programmed for storage and retrieval of customer reviews of service and restaurant menu item quality.

In further examples of the implementation of the restaurant management system, the restaurant management system processor may be programmed for applying a set of rules for analysis of the customer reviews [190] of service and restaurant menu item quality.

In additional examples of the implementation of the restaurant management system, the restaurant management system processor may be programmed for correlating the customer reviews with determined profit margins for a plurality of potential restaurant menu items.

In other examples of the implementation of the restaurant management system, the restaurant management database may be programmed for distributing, receiving, storing and retrieving the customer reviews as including customer surveys regarding restaurant customer service and food quality including positive and negative feedback, and wherein the restaurant management system processor may be programmed for analyzing the customer reviews for identifying patterns of positive and negative customer feedback concerning menu items and restaurant customer services.

In some examples of the implementation of the restaurant management system, the restaurant management system processor may be programmed for utilizing the patterns of positive and negative customer feedback concerning menu items in determining action steps regarding customer service quality.

In further examples of the implementation of the restaurant management system, the restaurant management system processor may be programmed for utilizing the patterns of positive and negative customer feedback concerning menu items in management of restaurant suppliers.

In additional examples of the implementation of the restaurant management system, the restaurant management database may be programmed for storage and retrieval of customer reservation data.

In other examples of the implementation of the restaurant management system, the restaurant management system processor may be programmed for utilizing the customer reservation data in real-time management of undersupplies and oversupplies of an inventory of an ingredient for a restaurant menu item.

In some examples of the implementation of the restaurant management system, the restaurant management system processor may be programmed for utilizing the customer reservation data in real-time management of restaurant table reservations and table assignments.

In further examples of the implementation of the restaurant management system, the restaurant management system processor may be programmed for utilizing the customer reservation data in communicating with a restaurant customer regarding table availability and assignment.

In additional examples of the implementation of the restaurant management system, the restaurant management system processor may be programmed for utilizing the customer reservation data in real-time communication with a restaurant customer regarding menu item availability and pricing.

In other examples of the implementation of the restaurant management system, the restaurant management system processor may be programmed for generating artificial intelligence training data for storage in and retrieval from the restaurant management database and for utilizing the artificial intelligence training data for analysis of potential outcomes in the customer reviews of customer service and restaurant menu item quality.

In some examples of the implementation of the restaurant management system, the restaurant management system processor may be programmed for correlating the artificial intelligence training data with the restaurant management data.

In further examples of the implementation of the restaurant management system, the restaurant management system processor may be programmed for generating optimal outcome data from the analysis of potential outcomes in the customer surveys and reviews of customer service and restaurant menu item quality.

In additional examples of the implementation of the restaurant management system, the restaurant management database may be programmed for storage and retrieval of customer order data.

In other examples of the implementation of the restaurant management system, the restaurant management system processor may be programmed for applying a set of rules for analysis of the customer order data.

In some examples of the implementation of the restaurant management system, the restaurant management database may be programmed for integrating the customer order data into the restaurant management data.

In further examples of the implementation of the restaurant management system, the restaurant management system processor may be programmed for utilizing the customer order data in monitoring restaurant staff performance and in carrying out restaurant staff training and discipline.

In additional examples of the implementation of the restaurant management system, the restaurant management system processor may be programmed for receiving customer order data from the Internet.

In other examples of the implementation of the restaurant management system, the restaurant management database may be programmed for storage and retrieval of restaurant customer contact information correlated with current and historical restaurant item ordering data, and wherein the restaurant management system processor may be programmed for real-time updating of the electronic restaurant menu display in response to the historical restaurant item ordering data.

In some examples of the implementation of the restaurant management system, the restaurant management system processor may be programmed for generating targeted advertising for a restaurant based on the historical restaurant item ordering data.

In further examples of the implementation of the restaurant management system, the restaurant management database may be programmed for storage and retrieval of restaurant customer menu item preference data, and wherein the restaurant management system processor may be programmed for real-time updating of the electronic restaurant menu display in response to the restaurant customer menu item preference data.

In additional examples of the implementation of the restaurant management system, the restaurant management database may be programmed for storage and retrieval of restaurant customer menu item selection and modification data, and wherein the restaurant management system processor may be programmed for real-time updating of the electronic restaurant menu display in response to the restaurant customer menu item selection and modification data.

In other examples of the implementation of the restaurant management system, the restaurant management system processor may be programmed for generating artificial intelligence training data for storage in and retrieval from the restaurant management database and for utilizing the artificial intelligence training data for analysis of potential outcomes in the customer order data, the customer preference data, or the customer menu item selection and modification data.

In some examples of the implementation of the restaurant management system, the restaurant management system processor may be programmed for correlating the artificial intelligence training data with the restaurant management data.

In further examples of the implementation of the restaurant management system, the restaurant management system processor may be programmed for generating optimal outcome data from the analysis of potential outcomes in the restaurant menu pricing data.

Other systems, devices, processes, features and advantages of the invention will be or will become apparent to one with skill in the art upon examination of the following figures and detailed description. It is intended that all such additional systems, devices, processes, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a schematic diagram showing examples [100] of an implementation of a restaurant management system.

FIG. 2 is another schematic diagram showing features that may be included in some of the examples [100] of the implementation of a restaurant management system.

FIG. 3 is a further schematic diagram showing further features that may be included in some of the examples [100] of the implementation of a restaurant management system.

FIG. 4 is an additional schematic diagram showing additional features that may be included in some of the examples [100] of the implementation of a restaurant management system

FIG. 5 is yet another schematic diagram showing features that may be included in some of the examples [100] of the implementation of a restaurant management system.

FIG. 6 is a schematic diagram showing other features that may be included in some of the examples [100] of the implementation of a restaurant management system.

FIG. 7 is a schematic diagram showing still further features that may be included in some of the examples [100] of the implementation of a restaurant management system.

FIG. 8 is a schematic diagram showing still additional features that may be included in some of the examples [100] of the implementation of a restaurant management system.

### DETAILED DESCRIPTION

Various restaurant management systems and methods have been developed. However, the challenges have never been greater to operate a commercially viable restaurant or chain of restaurants based on collection of strategic external marketplace and internal data and based on conversion of that data into intentional and competitive day-to-day internal and external restaurant operations. The restaurant business remains dominated by reactionary approaches leading to such problems as poorly defined data, stagnant data access, and failures to implement strategic data processing that effectively capitalizes on the potential value of the data by generating new types of data having significant direct value to the restaurant enterprise.

In view of these shortfalls while also considering a myriad of other commonplace circumstances, an example of a restaurant management system is provided herein, that includes a restaurant management database programmed for storage and retrieval of restaurant management data including restaurant supply pricing data being correlated with restaurant menu pricing data. Further, the example of the restaurant management system includes an electronic restaurant menu display for displaying the restaurant menu pricing data. Additionally, the restaurant management system includes a restaurant management system processor being programmed for control of the electronic restaurant menu display and for analysis of the restaurant management data. The restaurant management system processor is further programmed for receiving, analyzing and correlating together updated restaurant supply pricing data and updated restaurant menu pricing data forming updated restaurant management data. The restaurant management system processor is additionally programmed for communicating the updated restaurant management data to the restaurant management database. In addition, the restaurant management system processor is programmed for retrieving the updated restaurant menu pricing data from the restaurant management database and communicating the updated restaurant menu pricing data to the electronic restaurant menu display.

The following definitions of terms, being stated as applying “this specification”, are hereby deemed to be incorporated throughout this specification, including but not limited to the Summary, Brief Description of the Figures, Detailed Description, and Claims.

Throughout this specification, the term “Internet” (being a contraction of “interconnected network”), also referred to as the World Wide Web, is the global system of interconnected computer networks that use the Internet protocol suite to link devices worldwide.

Throughout this specification, the term “processor” means an electronic circuit that performs operations on a data source; and may include, as examples, a central processing unit and/or a specialized processor. Throughout this specification, the term “facility” means a specialized processor having a particular designated function.

Throughout this specification, the term “real-time” means taking place in the present. Notwithstanding any other statement in the specification and drawings, it is understood that any system element or process step stated as taking place or operating in “real-time” can alternatively be carried out or operate partially or completely on a non-“real-time”basis.

Throughout this specification, the term “supply” designates an ingredient or menu item for procurement by a restaurant.

It is understood throughout this specification that numbering of the names of elements as being “first”, “second” etcetera, is solely for purposes of clarity in referring to such elements in connection with various examples of restaurant management systems.

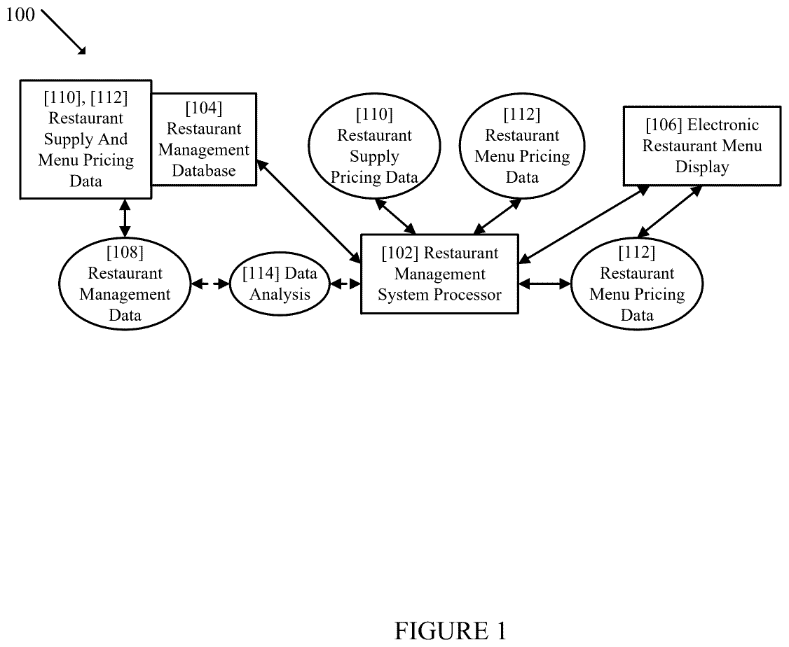

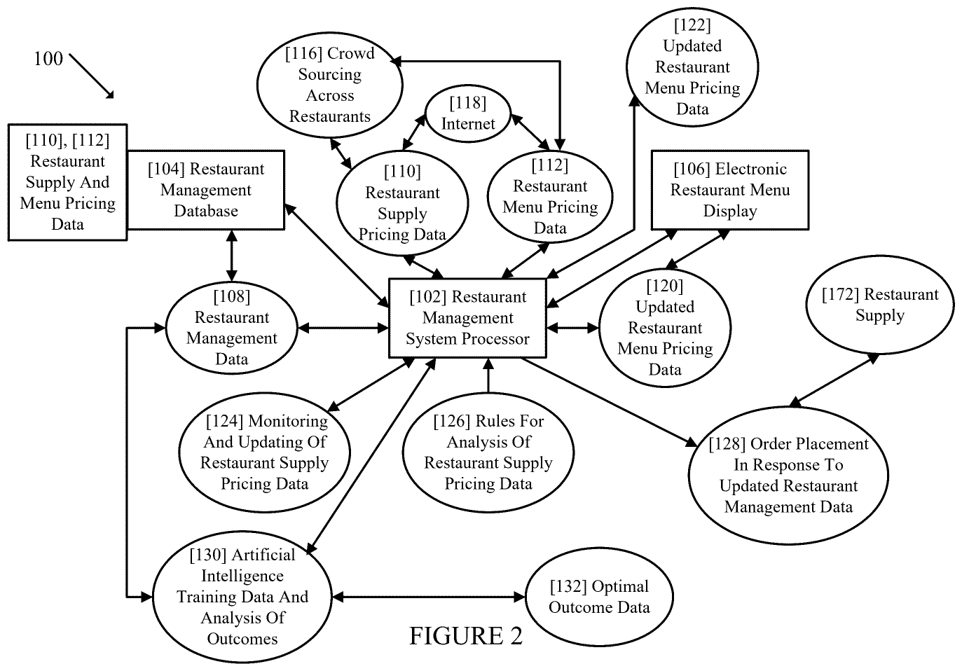

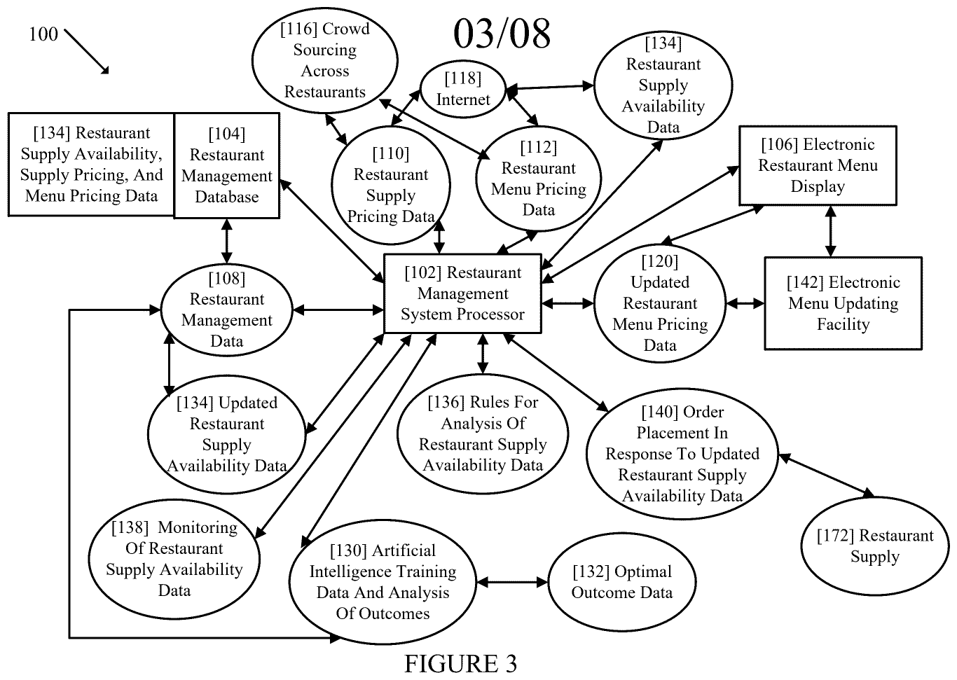

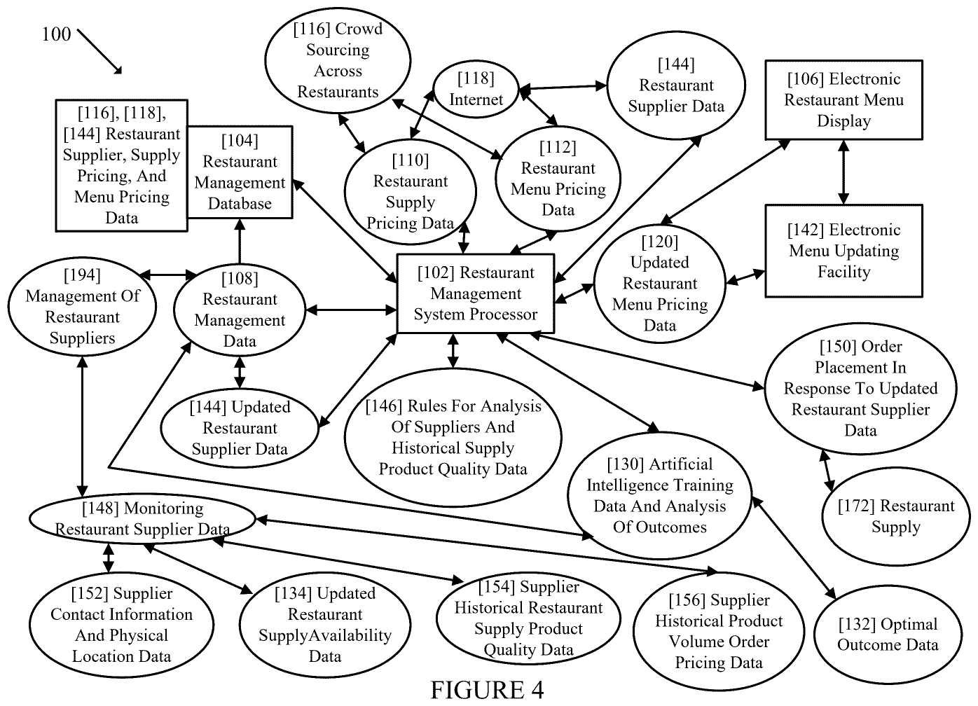

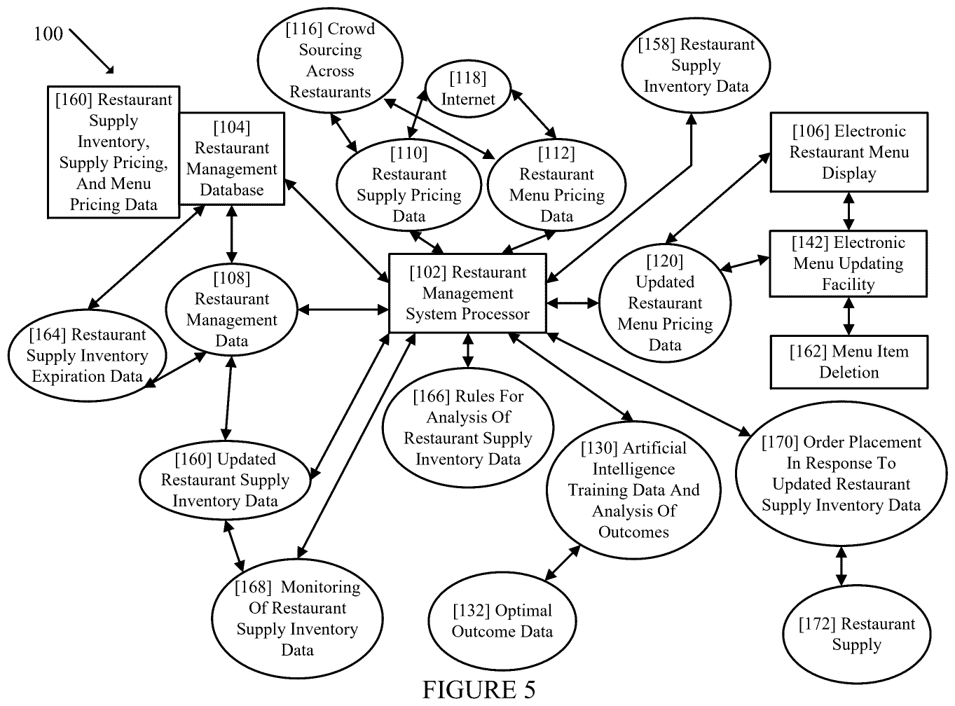

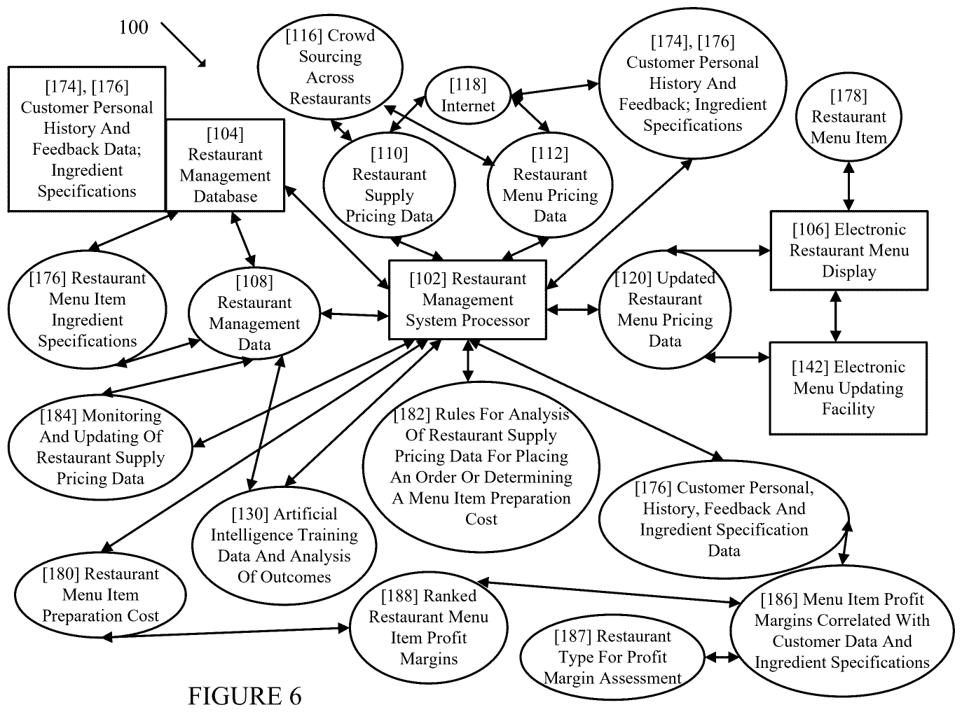

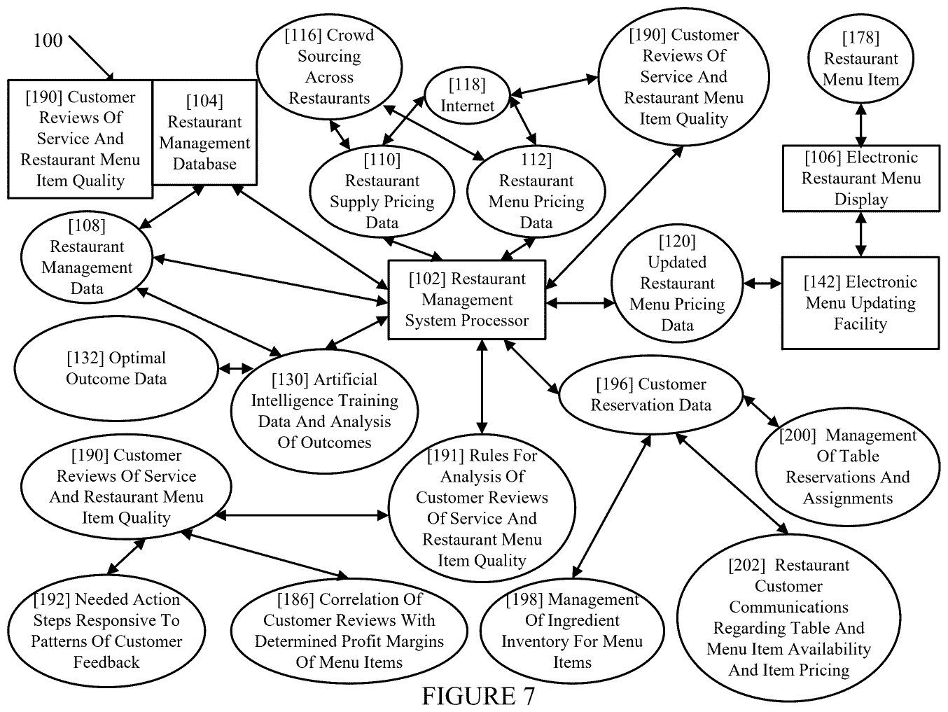

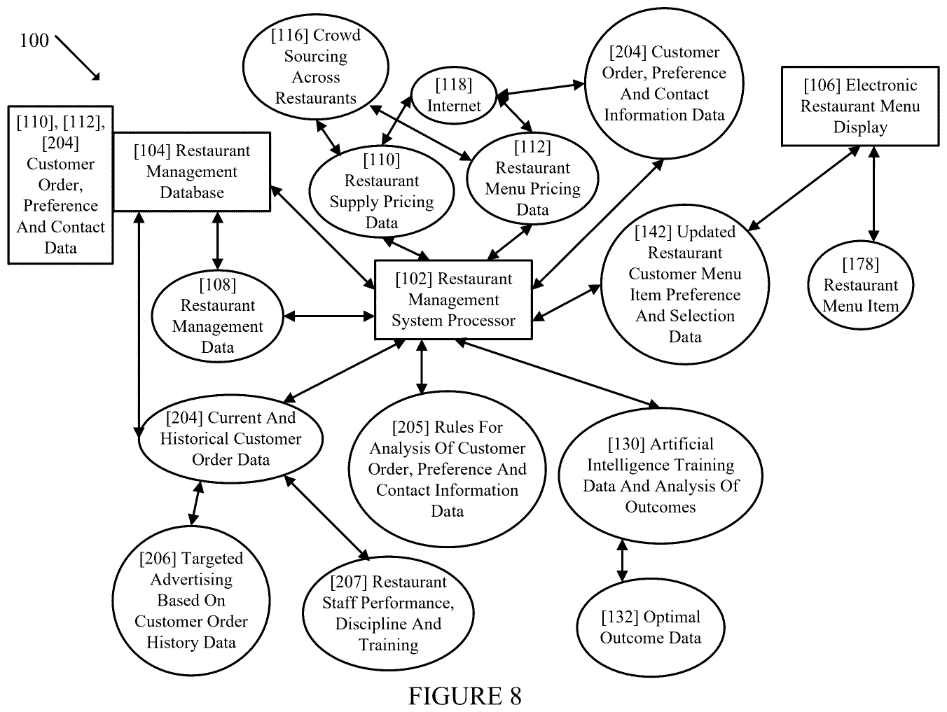

FIG. 1 is a schematic diagram showing examples [100] of an implementation of a restaurant management system. FIG. 2 is another schematic diagram showing features that may be included in some of the examples [100] of the implementation of a restaurant management system. FIG. 3 is a further schematic diagram showing further features that may be included in some of the examples [100] of the implementation of a restaurant management system. FIG. 4 is an additional schematic diagram showing additional features that may be included in some of the examples [100] of the implementation of a restaurant management system. FIG. 5 is yet another schematic diagram showing features that may be included in some of the examples [100] of the implementation of a restaurant management system. FIG. 6 is a schematic diagram showing other features that may be included in some of the examples [100] of the implementation of a restaurant management system FIG. 7 is a schematic diagram showing still further features that may be included in some of the examples [100] of the implementation of a restaurant management system. FIG. 8 is a schematic diagram showing still additional features that may be included in some of the examples [100] of the implementation of a restaurant management system. It is understood throughout this specification that an example [100] of a restaurant management system as illustrated in FIG. 1 may include any combination of the additional features that are discussed herein in connection with the further examples [100] of restaurant management systems as illustrated in FIGS. 2-8. Accordingly, the entireties of the discussions herein of the various features of the examples [100] of the restaurant management system as shown and discussed in connection with FIGS. 1-8 are deemed to collectively constitute the examples [100] of the restaurant management system.

As shown in FIG. 1, the example [100] of the implementation of the restaurant management system includes a restaurant management system processor [102], a restaurant management database [104], and an electronic restaurant menu display [106]. In the example [100] of the restaurant management system, the arrows shown in FIGS. 1-8 represent examples of two-way connectivity facilitating flows of data and of processing instructions. In the example [100] of the restaurant management system, the restaurant management database [104] is programmed for storage and retrieval of restaurant management data [108] including restaurant supply pricing data [110] being correlated with restaurant menu pricing data [112]. In the example [100] of the restaurant management system, the electronic restaurant menu display [106] is for displaying the restaurant menu pricing data [112]. Further in the example [100] of the restaurant management system, the restaurant management system processor [102] is programmed for control of the electronic restaurant menu display [106] and for analysis [114] of the restaurant management data [108]. In the example [100] of the restaurant management system, the restaurant management system processor [102] is programmed for receiving restaurant supply pricing data [110], restaurant menu pricing data [112], analyzing and correlating together [114] updated restaurant supply pricing data [110] and updated restaurant menu pricing data [112] producing updated restaurant management data [108], the restaurant management system processor [102] being programmed for communicating the updated restaurant management data [108] to the restaurant management database [104], the restaurant management system processor [102] being programmed for retrieving the updated restaurant menu pricing data [108] from the restaurant management database [104] and communicating the updated restaurant menu pricing data [112] to the electronic restaurant menu display [106]. In some examples [100] of the restaurant management system, the restaurant management system processor[102] may be programmed for generating some of the restaurant menu pricing data [112] by analyzing [114] the restaurant management data [108].

As shown in FIG. 2, the restaurant management system processor [102] may be programmed for receiving restaurant supply pricing data [110] from crowd sourcing [116] across a plurality of restaurants. In additional examples [100] of the restaurant management system, the restaurant management system processor [102] may be programmed for receiving restaurant menu pricing data [112] from crowd sourcing [116] across a plurality of restaurants. In some of those examples [100] of the restaurant management system, the restaurant management system processor [102] may be programmed for receiving restaurant supply pricing data [110] and restaurant menu pricing data [112] from internet crowd sourcing [118] across a plurality of restaurants.

In some examples [100] of the restaurant management system, the restaurant management system processor [102] may be programmed for real-time updating [120] of the restaurant menu pricing data [112]. Further in those examples [100] of the restaurant management system, the restaurant management system processor [102] may be programmed for real-time updating of the electronic restaurant menu display [106].

In additional examples [100] of the restaurant management system, the restaurant management system processor [102] may be programmed for real-time monitoring and updating [124] of the restaurant supply pricing data [110]. In further examples [100] of the restaurant management system, the restaurant management system processor [102] may be programmed for real-time updating [122] of the restaurant menu pricing data [112] in accordance with updated restaurant supply pricing data [110].

In other examples [100] of the restaurant management system, the restaurant management system processor [102] may be programmed for receiving a set of rules [126] for analysis of the restaurant supply pricing data [110] in correlating the updated restaurant supply pricing data [110] together with the updated restaurant menu pricing data [122]. In some examples [110] of the restaurant management system, the restaurant management system processor [102] may be programmed for receiving the set of rules [126] for analysis of the restaurant supply pricing data [110] as including a menu pricing scheme (not shown) tailored to a selected restaurant type in correlating the restaurant supply pricing data [110] with the restaurant menu pricing data [112] in the restaurant management data [108]. In further examples [100] of the restaurant management system, the set of rules [126] for analysis of the restaurant supply pricing data [110] may include set points for executing placement of an order [128] for a restaurant supply [172] when the restaurant supply pricing data [110] reach a specified amount. In other examples [100] of the restaurant management system, the restaurant management system processor [102] may be programmed for placing a limit order [128] for a restaurant supply [172] in response to the updated restaurant supply pricing data [124].

In some examples [100] of the restaurant management system, the restaurant management system processor [102] may be programmed for generating artificial intelligence training data [130] for storage in and retrieval from the restaurant management database [104] and for utilizing the artificial intelligence training data [130] for analysis of potential outcomes in the restaurant menu pricing data [122]. In those examples[100] of the restaurant management system, the restaurant management system processor [102] may be programmed for correlating the artificial intelligence training data [130] with the restaurant management data [108]. Further in those examples [100] of the restaurant management system, the restaurant management system processor [102] may be programmed for generating optimal outcome data [132] from the analysis [130] of potential outcomes in the restaurant menu pricing data [122].

In other examples [100] of the restaurant management system, the restaurant management system processor [102] may be programmed for receiving the updated restaurant supply pricing data [110] from the Internet [118] and for causing the restaurant supply pricing data [110] stored in the restaurant management database [104] to be updated in accordance with the updated restaurant supply pricing data [122].

As shown in FIG. 3, the restaurant management database [104] may be programmed for storage and retrieval of restaurant supply availability data [134]. In some examples [100] of the restaurant management system, the restaurant management system processor [102] may be programmed for correlating the restaurant supply availability data [134] with the restaurant management data [108]. In other examples [100] of the restaurant management system, the restaurant management system processor [102] may be programmed for receiving updated restaurant supply availability data [134] and for causing the restaurant supply availability data [134] stored in the restaurant management database [104] to be updated in accordance with the updated restaurant supply availability data [134]. In some examples [100] of the restaurant management system, the restaurant management system processor [102] may be programmed for real-time updating [120] of the restaurant menu pricing data [112] in accordance with the updated restaurant supply availability data [134]. In further examples [100] of the restaurant management system, the restaurant management system processor [102] may be programmed for receiving a set of rules [136] for analysis of the restaurant supply availability data [134] in correlating the restaurant supply availability data [134] together with the restaurant menu pricing data [120]. In examples [100] of the restaurant management system, the restaurant management system processor [102] may be programmed for monitoring [138] of the restaurant supply availability data [134]. In some examples [100] of the restaurant management system, the restaurant management system processor [102] may be programmed for placing an order [140] for a restaurant supply [172] in response to the updated restaurant supply availability data [134]. In additional examples [110] of the restaurant management system, the restaurant management system processor [102] may be programmed for placing a limit order for a restaurant supply [172] in response to the updated restaurant supply availability data [134].

In other examples [100] of the restaurant management system, the restaurant management system processor may be programmed for generating artificial intelligence training data [130] for storage in and retrieval from the restaurant management database [104] and for utilizing the artificial intelligence training data [130] for analysis of potential outcomes in the restaurant menu pricing data [120]. In some examples [100] of the restaurant management system, the restaurant management system processor [102] may be programmed for correlating the artificial intelligence training data [130] with the restaurant management data [108]. In additional examples [100] of the restaurant management system, the restaurant management system processor [102] may be programmed for generating optimal outcome data [132] from the analysis [136] of potential outcomes in the restaurant supply availability data [134].

In other examples [100] of the restaurant management system, the restaurant management system processor [102] may be in communication with an electronic menu updating facility [142]. In some of those examples [100] of the restaurant management system, the restaurant management system processor may be programmed for utilizing the electronic menu updating facility [142] for real-time updating [120] of the electronic restaurant menu display [106].

As shown in FIG. 4, the restaurant management database [104] may be programmed for storage and retrieval of restaurant supplier data [144]. In additional examples [100] of the restaurant management system, the restaurant management system processor [102] may be programmed for correlating the restaurant supplier data [144] with the restaurant management data [108]. In further examples [100] of the restaurant management system, the restaurant management system processor [102] may be programmed for receiving updated restaurant supplier data [144] and for causing the restaurant supplier data [144] stored in the restaurant management database [104] to be updated in accordance with the updated restaurant supplier data [144]. In examples [100] of the restaurant management system, the restaurant management system processor [102] may be programmed for real-time updating of the restaurant menu pricing data [120] in accordance with the updated restaurant supplier data [144]. In further examples [100] of the restaurant management system, the restaurant management system processor [102] may be programmed for receiving a set of rules [146] for analysis of the restaurant supplier data [144] in correlating the restaurant supplier data [144] together with the restaurant menu pricing data [120].

In additional examples [100] of the restaurant management system, the restaurant management system processor [102] may be programmed for real-time monitoring [148] of the restaurant supplier data[144]. In some examples [100] of the restaurant management system, the restaurant management system processor [102] may be programmed for management [194] of the restaurant suppliers. In further examples [100] of the restaurant management system, the restaurant management system processor [102] may be programmed for placing an order [150] for a restaurant supply [172] in response to the updated restaurant supplier data [144]. In other examples [100] of the restaurant management system, the restaurant management system processor [102] may be programmed for placing a limit order [150] for a restaurant supply [172] in response to the updated restaurant supplier data [144].

In other examples [100] of the restaurant management system, the restaurant management system processor [102] may be programmed for generating artificial intelligence training data [130] for storage in and retrieval from the restaurant management database [104] for analysis of potential outcomes in the restaurant supplier data [144]. In those examples [100] of the restaurant management system, the restaurant management system processor [102] may be programmed for correlating the artificial intelligence training data [130] with the restaurant management data [108]. In further examples [100] of the restaurant management system, the restaurant management system processor [102] may be programmed for generating optimal outcome data [132] from analysis of potential outcomes in the restaurant supplier data [144].

In some examples [100] of the restaurant management system, the restaurant management database [104] may be programmed for storage and retrieval of the restaurant supplier data [144] as including contact information and physical locations [152] of restaurant suppliers. In additional examples [100] of the restaurant management system, the restaurant management database [104] may be programmed for storage and retrieval of historical restaurant supply product quality data [154] correlated with the contact information and physical locations [152] of restaurant suppliers. In further examples [100] of the restaurant management system, the restaurant management system processor [102] may be programmed for correlating the historical restaurant supply product quality data [154] with the restaurant management data [108].

In additional examples [100] of the restaurant management system, the restaurant management system processor [102] may be programmed for receiving a set of rules [146] for analysis of the historical restaurant supply product quality data [154] in carrying out the correlating of the historical restaurant supply product quality data [154] with the restaurant management data [108]. In some examples [100] of the restaurant management system, the restaurant management database [104] may be programmed for storage and retrieval of historical restaurant supply product quality data [154] correlated with updated restaurant supplier data [144]. In some examples [100] of the restaurant management system, the restaurant management database [104] may be programmed for storage and retrieval of supplier historical product volume order pricing data [156] correlated with the contact information and physical locations [152] of restaurant suppliers. In additional examples [100] of the restaurant management system, the restaurant management database [104] may be programmed for storage and retrieval of updated restaurant supply availability data [134] correlated with the contact information and physical locations [152] of restaurant suppliers.

As shown in FIG. 5, the restaurant management database [104] may be programmed for storage and retrieval of restaurant supply inventory data [158]. In some examples [100] of the restaurant management system, the restaurant management system processor [102] may be programmed for correlating the restaurant supply inventory data [158] with the restaurant management data [108]. In further examples [100] of the restaurant management system, the restaurant management system processor [102] may be programmed for receiving updated restaurant supply inventory data [158] and for causing the restaurant supply inventory data [160] stored in the restaurant management database [104] to be updated in accordance with the updated restaurant supply inventory data [158]. In examples [100] of the restaurant management system, the restaurant management system processor [102] may be programmed for real-time updating of the restaurant menu pricing data [120] in accordance with the updated restaurant supply inventory data [160]. In examples [100] of the restaurant management system, the restaurant management system processor [102] may be programmed for updating the electronic restaurant menu display [106] in accordance with the updated restaurant supply inventory data [160]. In some examples [110] of the restaurant management system, the restaurant management system processor [102] may be programmed for temporarily or permanently deleting [162] a menu item from the electronic restaurant menu display [106] in response to the updated restaurant supply inventory data [160] or the updated restaurant supply pricing data [110].

In other examples [100] of the restaurant management system, the restaurant management database [104] may be programmed for storage and retrieval of the restaurant supply inventory data [160] as including restaurant supply inventory expiration data [164], and the restaurant management system processor [102] may be programmed for utilizing the restaurant supply inventory expiration data [164] in updating the restaurant supply inventory data [160].

In some examples [100] of the restaurant management system, the restaurant management system processor [102] may be programmed for receiving a set of rules [166] for analysis of the restaurant supply inventory data [158] in correlating the restaurant supply inventory data [160] together with the restaurant management data [108]. In additional examples [100] of the restaurant management system, the restaurant management system processor [102] may be programmed for real-time monitoring [168] of the restaurant supply inventory data [158]. In further examples [100] of the restaurant management system, the restaurant management system processor [102] may be programmed for placing an order [170] for a restaurant supply [172] in response to the updated restaurant supply inventory data [160]. In some examples [100] of the restaurant management system, the restaurant management system processor [102] may be programmed for placing a limit order [170] for a restaurant supply [172] in response to the updated restaurant supply inventory data [160].

In other examples [100] of the restaurant management system, the restaurant management system processor [102] may be programmed for generating artificial intelligence training data [130] relating to the restaurant supply inventory data [160] for storage in and retrieval from the restaurant management database [104] for analysis of potential outcomes [130] in the restaurant supply inventory data [160]. In some examples [100] of the restaurant management system, the restaurant management system processor [102] may be programmed for correlating the artificial intelligence training data [130] that relates to the restaurant supply inventory data [160] together with the restaurant management data [108]. In other examples [100] of the restaurant management system, the restaurant management system processor [102] may be programmed for generating optimal outcome data [132] from the analysis of potential outcomes in the restaurant supply inventory data [160]. In additional examples [100] of the restaurant management system, the restaurant management system processor [102] may be in communication with an electronic menu updating facility [142]. In further examples [100] of the restaurant management system, the restaurant management system processor [102] may be programmed for utilizing the electronic menu updating facility [142] for real-time updating of the electronic restaurant menu display [106].

As shown in FIG. 6, the restaurant management database [104] may be programmed for storage and retrieval of customer personal history and feedback data [174]. In further examples [110] of the restaurant management system, the restaurant management database [104] may be programmed for storage and retrieval of restaurant menu item ingredient specifications [176]. In other examples [100] of the restaurant management system, the restaurant management database may be programmed for storage and retrieval of ingredient specifications [176] for a restaurant menu item [178], and the restaurant management system processor [102] may be programmed for determining a preparation cost [180] for the restaurant menu item [178] by applying a set of rules [182] for analysis of the restaurant supply pricing data [110]. In other examples [100] of the restaurant management system, the restaurant management system processor [102] may be programmed for receiving restaurant menu pricing data [112] from crowd sourcing [116] across a plurality of restaurants. In some examples [100] of the restaurant management system, the restaurant management system processor [102] may be programmed for receiving restaurant supply pricing data [110] and restaurant menu pricing data [112] from internet crowd sourcing [118] across a plurality of restaurants. In other examples [100] of the restaurant management system, the restaurant management system processor [102] may be programmed for real-time updating of the restaurant menu pricing data [120]. In additional examples [100] of the restaurant management system, the restaurant management system processor [102] may be programmed for real-time updating of the electronic restaurant menu display [106]. In examples of the restaurant management system, the restaurant management system processor [102] may be programmed for real-time monitoring or updating [184] of the restaurant supply pricing data [110]. In further examples [100] of the restaurant management system, the restaurant management system processor [102] may be programmed for real-time updating [120] of the restaurant menu pricing data [112] in accordance with the updated restaurant supply pricing data [184]. In examples [100] of the restaurant management system, the restaurant management system processor [102] may be programmed for receiving the set of rules [182] for analysis of the restaurant supply pricing data [184] as including a menu pricing scheme tailored to a selected restaurant type [187] in correlating the restaurant supply pricing data [110] with the restaurant menu pricing data [120] in the restaurant management data [108]. As examples, the selected restaurant types may include: restaurants having low, mid or high price-points; restaurants having limited or specific hours of operation; restaurants serving particular ethnic foods; and restaurants specializing in particular food classes, such as breakfast, lunch, dinner, dessert, or beverages. In other examples [100] of the restaurant management system, the set of rules for analysis of the restaurant supply pricing data [184] may include set points for executing placement of an order for a restaurant menu item or an ingredient when the restaurant supply pricing data [110] reach a specified amount. In examples [100] of the restaurant management system, the restaurant management system processor [102] may be programmed for generating artificial intelligence training data [130] for storage in and retrieval from the restaurant management database [104] and for utilizing the artificial intelligence training data [130] for analysis of potential outcomes in the customer personal history and feedback data [174]. In additional examples[100] of the restaurant management system, the restaurant management system processor [102] may be programmed for correlating the artificial intelligence training data [130] with the restaurant management data [108]. In examples [100] of the restaurant management system, the restaurant management system processor [102] may be programmed for generating optimal outcome data (not shown) from analysis of potential outcomes in the customer personal history and feedback data [174].

In other examples [100] of the restaurant management system, the restaurant management system processor may be programmed for generating artificial intelligence training data [130] for storage in and retrieval from the restaurant management database [104] and for utilizing the artificial intelligence training data [130] for analysis of potential outcomes (not shown) in the ingredient specifications. In further examples [100] of the restaurant management system, the restaurant management system processor [102] may be programmed for correlating the artificial intelligence training data [130] with the restaurant management data [108]. In additional examples [100] of the restaurant management system, the restaurant management system processor [102] may be programmed for generating optimal outcome data (not shown) from the analysis of potential outcomes in the ingredient specifications [176] and the customer personal history and feedback data [174].

In other examples [100] of the restaurant management system, the restaurant management system processor [102] may be programmed for receiving the updated restaurant supply pricing data [110] from the Internet and for causing the restaurant supply pricing data [184] stored in the restaurant management database [104] to be updated in accordance with the updated restaurant supply pricing data [110]. In additional examples [100] of the restaurant management system, the restaurant management system processor [102] may be programmed for determining a profit margin [186] for a restaurant menu item [178] based on a determined preparation cost [180]. In examples [100] of the restaurant management system, the restaurant management system processor [102] may be programmed for ranking determined profit margins [188] for a plurality of potential restaurant menu items [178] based on their respective determined preparation costs [180]. In some examples [100] of the restaurant management system the restaurant management system processor [102] may be programmed for correlating the profit margins [188] with the customer personal history or feedback data [174] or ingredient specification data [176] in the restaurant management data [108].

As shown in FIG. 7, the restaurant management database [104] may be programmed for storage and retrieval of customer reviews [190] of service and restaurant menu item quality. In other examples [100] of the restaurant management system, restaurant management system processor [102] may be programmed for applying a set of rules [191] for analysis of the customer reviews [190] of service and restaurant menu item quality. In some of those examples [100] of the restaurant management system, the restaurant management system processor [102] may be programmed for correlating the customer reviews [190] with determined profit margins [186] for a plurality of potential restaurant menu items [178]. In further examples [100] of the restaurant management system, the restaurant management database [104] may be programmed for distributing, receiving, storing and retrieving the customer reviews [190] as including customer surveys regarding restaurant customer service and food quality including positive and negative feedback. In additional examples [100] of the restaurant management system, the restaurant management system processor [102] may be programmed for analyzing the customer reviews for identifying patterns of positive and negative customer feedback concerning menu items [178] and restaurant customer services. In some examples [100] of the restaurant management system, the restaurant management system processor [102] may be programmed for utilizing the patterns of positive and negative customer feedback concerning menu items in determining action steps [192] regarding customer service quality. In further examples [100] of the restaurant management system, the restaurant management system processor [102] may be programmed for utilizing the patterns of positive and negative customer feedback in management [194] of restaurant suppliers.

In additional examples [100] of the restaurant management system, the restaurant management database [104] may be programmed for storage and retrieval of customer reservation data [196]. In some of those examples [100] of the restaurant management system, the restaurant management system processor [102] may be programmed for utilizing the customer reservation data [196] in real-time management [198] of undersupplies and oversupplies of an inventory of an ingredient for a restaurant menu item [178]. In further examples [100] of the restaurant management system, the restaurant management system processor [102] may be programmed for utilizing the customer reservation data [196] in real-time management [200] of restaurant table reservations and table assignments. In some of those examples [100] of the restaurant management system, the restaurant management system processor [102] may be programmed for utilizing the customer reservation data [196] in communicating [202] with a restaurant customer regarding table availability and assignment. In further examples [100] of the restaurant management system, the restaurant management system processor [102] may be programmed for utilizing the customer reservation data [196] in real-time communication [202] with a restaurant customer regarding menu item availability and pricing.

In some examples [100] of the restaurant management system, the restaurant management system processor [102] may be programmed for generating artificial intelligence training data [130] for storage in and retrieval from the restaurant management database [104], and for utilizing the artificial intelligence training data [130] for analysis of potential outcomes in the customer reviews [190] of customer service and restaurant menu item quality. In further examples [100] of the restaurant management system, the restaurant management system processor [102] may be programmed for correlating the artificial intelligence training data [130] with the restaurant management data [108]. In additional examples [100] of the restaurant management system, the restaurant management system processor [102] may be programmed for generating optimal outcome data [132] from the analysis of potential outcomes in the customer surveys and reviews of customer service and restaurant menu item quality.

As shown in FIG. 8, the restaurant management database [104] may be programmed for storage and retrieval of customer order data [204]. In additional examples [100] of the restaurant management system, the restaurant management system processor may be programmed for applying a set of rules [205] for analysis of the customer order data. In further examples [100] of the restaurant management system, the restaurant management database [104] may be programmed for integrating the customer order data [204] into the restaurant management data [108]. In additional examples [100] of the restaurant management system, the restaurant management system processor [102] may be programmed for utilizing the customer order data [204] in monitoring restaurant staff performance and in carrying out restaurant staff training and discipline [207]. In further examples [100] of the restaurant management system, the restaurant management system processor [102] may be programmed for receiving customer order data [204] from the Internet 118. In additional examples [100] of the restaurant management system, the restaurant management database [104] may be programmed for storage and retrieval of restaurant customer contact information data [204], and the restaurant customer contact information data [204] may be correlated with current and historical restaurant item order data [204]. In some examples [100] of the restaurant management system, the restaurant management system processor [102] may be programmed for real-time updating [142] of the electronic restaurant menu display [106] in response to the historical restaurant item ordering data [204]. In some examples of the restaurant management system, the restaurant management system processor [102] may be programmed for generating targeted advertising [206] for a restaurant based on the historical restaurant item ordering data [204]. In other examples [100] of the restaurant management system, the restaurant management database [104] may be programmed for storage and retrieval of restaurant customer menu item preference data [204], and the restaurant management system processor [102] may be programmed for real-time updating [142] of the electronic restaurant menu display [106] in response to the restaurant customer menu item preference data [204]. In further examples [100] of the restaurant management system, the restaurant management database [104] may be programmed for storage and retrieval of restaurant customer menu item selection and modification data [204], and the restaurant management system processor [102] may be programmed for real-time updating [142] of the electronic restaurant menu display [106] in response to the restaurant customer menu item selection and modification data [204].

In additional examples [100] of the restaurant management system, the restaurant management system processor [102] may be programmed for generating artificial intelligence training data [130] for storage in and retrieval from the restaurant management database [104]. In some of those examples [100] of the restaurant management system, the restaurant management system processor [102] may be programmed for utilizing the artificial intelligence training data for analysis of potential outcomes in the customer order data [204], the customer preference data [204], or the customer menu item selection and modification data [204]. In further examples of the restaurant management system, the restaurant management system processor [102] may be programmed for correlating the artificial intelligence training data [130] with the restaurant management data [108]. In additional examples [100] of the restaurant management system, the restaurant management system processor may be programmed for generating optimal outcome data [132] from the analysis of potential outcomes in the customer menu item selection and modification data.

While the present invention has been disclosed in a presently defined context, it will be recognized that the present teachings may be adapted to a variety of contexts consistent with this disclosure and the claims that follow. The restaurant management system may be utilized, for example, in operating a restaurant or chain of restaurants with the support of restaurant management data that includes restaurant supply pricing data being correlated with restaurant menu pricing data.

(1). A restaurant management system, comprising:
a restaurant management database programmed for storage and retrieval of restaurant management data including restaurant supply pricing data being correlated with restaurant menu pricing data;
an electronic restaurant menu display for displaying the restaurant menu pricing data; and
a restaurant management system processor being programmed for control of the electronic restaurant menu display and for analysis of the restaurant management data, the restaurant management system processor being programmed for receiving, analyzing and correlating together updated restaurant supply pricing data and updated restaurant menu pricing data forming updated restaurant management data, the restaurant management system processor being programmed for communicating the updated restaurant management data to the restaurant management database, the restaurant management system processor being programmed for retrieving the updated restaurant menu pricing data from the restaurant management database and communicating the updated restaurant menu pricing data to the electronic restaurant menu display.

2). The restaurant management system of claim 1, wherein the restaurant management system processor is programmed for generating some of the restaurant menu pricing data by analyzing the restaurant management data.

3). The restaurant management system of claim 1, wherein the restaurant management system processor is programmed for receiving restaurant supply pricing data from crowd sourcing across a plurality of restaurants.

4). The restaurant management system of claim 1, wherein the restaurant management system processor is programmed for receiving restaurant menu pricing data from crowd sourcing across a plurality of restaurants.

5). The restaurant management system of claim 1, wherein the restaurant management system processor is programmed for receiving restaurant supply pricing data and restaurant menu pricing data from internet crowd sourcing across a plurality of restaurants.

6). The restaurant management system of claim 1, wherein the restaurant management system processor is programmed for real-time updating of the restaurant menu pricing data.

7). The restaurant management system of claim 1, wherein the restaurant management system processor is programmed for real-time updating of the electronic restaurant menu display.

8). The restaurant management system of claim 1, wherein the restaurant management system processor is programmed for real-time monitoring of the restaurant supply pricing data.

9). The restaurant management system of claim 1, wherein the restaurant management system processor is programmed for real-time updating of the restaurant menu pricing data in accordance with the updated restaurant supply pricing data.

10). The restaurant management system of claim 1, wherein the restaurant management system processor is programmed for receiving a set of rules for analysis of the restaurant supply pricing data in correlating the restaurant supply pricing data together with the restaurant menu pricing data.

11). (canceled)

12). The restaurant management system of claim 1, wherein the restaurant management system processor is programmed for receiving a set of rules for analysis of the restaurant supply pricing data in correlating the restaurant supply pricing data together with the restaurant menu pricing data, and wherein the set of rules for analysis of the restaurant supply pricing data includes set points for executing placement of an order for a restaurant supply when the restaurant supply pricing data reach a specified amount.

13). (canceled)

14). The restaurant management system of claim 1, wherein the restaurant management system processor is programmed for generating artificial intelligence training data for storage in and retrieval from the restaurant management database and for utilizing the artificial intelligence training data for analysis of potential outcomes in the restaurant menu pricing data.

15-16). (canceled)

17). The restaurant management system of claim 1, wherein the restaurant management system processor is programmed for receiving the updated restaurant supply pricing data from the Internet and for causing the restaurant supply pricing data stored in the restaurant management database to be updated in accordance with the updated restaurant supply pricing data.

18). The restaurant management system of claim 1, wherein the restaurant management database is programmed for storage and retrieval of restaurant supply availability data.

19-30). (canceled)

31). The restaurant management system of claim 1, wherein the restaurant management database is programmed for storage and retrieval of restaurant supplier data.

32-47). (canceled)

48). The restaurant management system of claim 1, wherein the restaurant management database is programmed for storage and retrieval of restaurant supply inventory data.

49-57). (canceled)

58). The restaurant management system of claim 1, wherein the restaurant management system processor is programmed for placing an order for a restaurant supply in response to the updated restaurant supply inventory data.

59-64). (canceled)

65). The restaurant management system of claim 1, wherein the restaurant management database is programmed for storage and retrieval of customer personal history and feedback data.

66). The restaurant management system of claim 1, wherein the restaurant management database is programmed for storage and retrieval of restaurant menu item ingredient specifications.

67-85). (canceled)

86). The restaurant management system of claim 1, wherein the restaurant management database is programmed for storage and retrieval of customer reviews of service and restaurant menu item quality.

87-111). (canceled)
